(19) United States
(12) Patent Application Publication
(10) Pub. No.: US 2019/0168300 A1
(43) Pub. Date: Jun. 6, 2019

(54) Method for Making Metal Objects by 3D Printing

(71) Applicant: Daniel Gelbart, Vancouver (CA)

(72) Inventor: Daniel Gelbart, Vancouver (CA)

(21) Appl. No.: 15/905,508

(22) Filed: Feb. 26, 2018

Related U.S. Application Data
(60) Provisional application No. 62/511,085, filed on May 25, 2017.

(51) Int. Cl. B22F 3/00; B22F 3/20; B29C 64/165; B29C 64/40; B28B 1/00; B33Y 10/00; B33Y 70/00

(52) U.S. Cl. CPC B22F 3/008; B22F 3/20; B29C 64/165; B29C 64/118; B28B 1/001; B33Y 10/00; B33Y 70/00; B29C 64/40

(57) ABSTRACT

A metal object is created, layer by layer, by extruding a metallic water-based paste containing a low amount of binder, using a positive displacement pump located near the nozzle. A support structure is created by a second pump using a low strength water-based paste. The object is partially dried as it is printed, followed by full drying and sintering.

### BACKGROUND OF THE INVENTION

The invention relates to the field of 3D printing of metal objects, also known as “additive manufacturing” or “rapid prototyping”. In 3D printing, a 3D object is created by building it layer by layer. The term “3D printing” in this disclosure should be widely interpreted as any method that builds up a 3D object from computer data. There are two main technologies for directly 3D printing metal objects: laser powder bed fusion and sintering. In the first one, a laser creates a layer of the object by melting the desired shape in a layer of powdered metal. As successive layers of powder are melted, the object is built up layer by layer. While this method is sometimes referred to as “Laser Sintering”, it is actually rapid melting. Powder bed fusion can also be done with an electron beam. The term “sintering” in this disclosure refers to the slow process in which particles fuse together to form a solid, typically over several hours. In the sintering method, the metal powder forming the object is temporarily held together by a binder. The binder can be sprayed on a metal powder layer or can be mixed with the metal powder to form a wire or filament than can be melted at a low temperature and deposited in a conventional FDM (Fused Deposition Modelling) type 3D printer. FDM type 3D printers are the most common type of plastic 3D printers. Two examples of FDM printers that can print a metal-filled polymeric material are made by the Markforged, Inc. (USA) and by the Desktop Metal, Inc. (USA). After the metal-filled polymer item is created, at least two more steps are required: de-binding (i.e. removing most of the polymeric binder) and sintering. In the de-binding step, a solvent is used to dissolve and remove the majority of the polymeric binder, leaving a “backbone” binder to hold the metal powder together for sintering. In this method it is not possible to use a very low amount of polymeric binder to start with, as the material needs to melt at a low temperature and flow freely to be compatible with FDM machines. This technology is an extension of the well known MIM (Metal Injection Molding) technology, in which a metal filled polymer is melted and injection molded. The de-binding operation adds a significant delay, as it takes several hours. De-binding also places restrictions on the shapes of the objects that can be 3D printed, as thick walls are difficult to de-bind. It also creates a disposal problem for the dissolved polymer. In the sintering step, a reducing gas is used to remove the metal oxides. The most commonly used reducing gas is hydrogen.

Prior art discloses a MIM process not requiring de-binding. For example, both U.S. Pat. Nos. 4,734,237 and 5,985,208 disclose using agar as a binder that can be burned off during sintering. These patents still require large amounts of binder. US patent application 2017/0246686 also discloses a process not requiring de-binding, using gelatin instead of agar. There have been other attempts to develop a de-binding free MIM process, as outlined in the paper “Metal Powder Injection Molding Moves Into Larger Parts” (Plastics Technology, an online magazine, Jun. 4, 2010) www.ptonline.com/articles/metal-powder-injection-molding-moves-into-larger-parts); however, the process still relies on melting the metal-binder composition in order to form it into a paste.

Low amounts of binder are desirable for several reasons: eliminating the de-binding step, reducing shrinkage by increasing green (i.e. pre-sintered) object density, and reducing emissions. The key to using low amounts of binder, or no binder at all, is to 3D print the object from a room-temperature paste rather than a metal-filled molten polymer. Some prior art tries to solve the problem by 3D printing with semi-molten metal and no binder at all. The very high temperatures required make it very difficult. An example is U.S. Pat. No. 5,893,404.

The main problem when printing from a paste is the shear-thinning behaviour of such pastes. A secondary problem, when using water-based metal pastes, is the tendency of the water to separate from the paste. It was found that the prior art methods of metal 3D printing using room temperature water-based metal pastes did not give satisfactory results because of the type of pump and feeder used. The metal paste is somewhat compressible because of dissolved air and because of the compressibility of water. Any pumping or feeding system that has a trapped volume of more than about 1 ml between the pump and the nozzle will drip, i.e. there will be some small leakage from the nozzle after the pump stops. This is easy to see from the following calculation: If 1 ml of paste is compressed by 0.1%, or 1 mm³, it will cause a 3 mm long drip from a 0.4 mm nozzle. Since the resolution of the 3D printed object is supposed to be much better than 3 mm, this is not acceptable. Prior art metal 3D printers use a syringe as a feed pump. A syringe has a large, and variable, trapped paste volume. The fact the trapped volume is variable makes it difficult to implement drip compensation schemes, such as reversing the pump before stopping. Examples of syringe-based paste 3D printers are U.S. Pat. Nos. 6,027,326; 9,327,448 and the Mini Metal Maker 3D metal printer described at www.minimetalmaker.com. Other designs use auger pumps. Since these are not positive displacement pumps, the high feed pressure required to bring the paste to the pump causes it to leak. Once a leak starts, it tends to increase because of the shear-thinning behaviour of the paste.

A common requirement in all 3D printers, both metal and plastic, is the need for a support system for over-hanging parts of the printed object. Current systems use the same metal being sintered as a support system, as disclosed in U.S. Pat. Nos. 9,833,839 and 9,815,118. A separation layer between the metal support and the metal object simplifies the removal of the supports. The disadvantage of these prior art support systems is that they waste a lot of the metal. The amount of metal used in the support structure can exceed the amount used to form the object. It is desirable to create a support system from a lower cost material, preferably a ceramic water-based paste, that can be deposited using the same system as the metal paste deposition. These supports can be removed before sintering or can be made of a material compatible with the sintering cycle.

### SUMMARY OF THE INVENTION

A metal object is created, layer by layer, by extruding a metallic water-based paste containing a low amount of binder, using a positive displacement pump. A support structure is created by a second pump using a low strength water-based paste. The object is dried to remove the water and sintered.

### DESCRIPTION OF THE DRAWINGS

FIG. 1 shows the general layout of the invention.

FIG. 2 shows the cross section of the metering pump and the nozzle.

FIG. 3 shows a cross section of an alternate method, using a polymeric 3D printed shell that is filled with metal paste.

### DETAILED DESCRIPTION

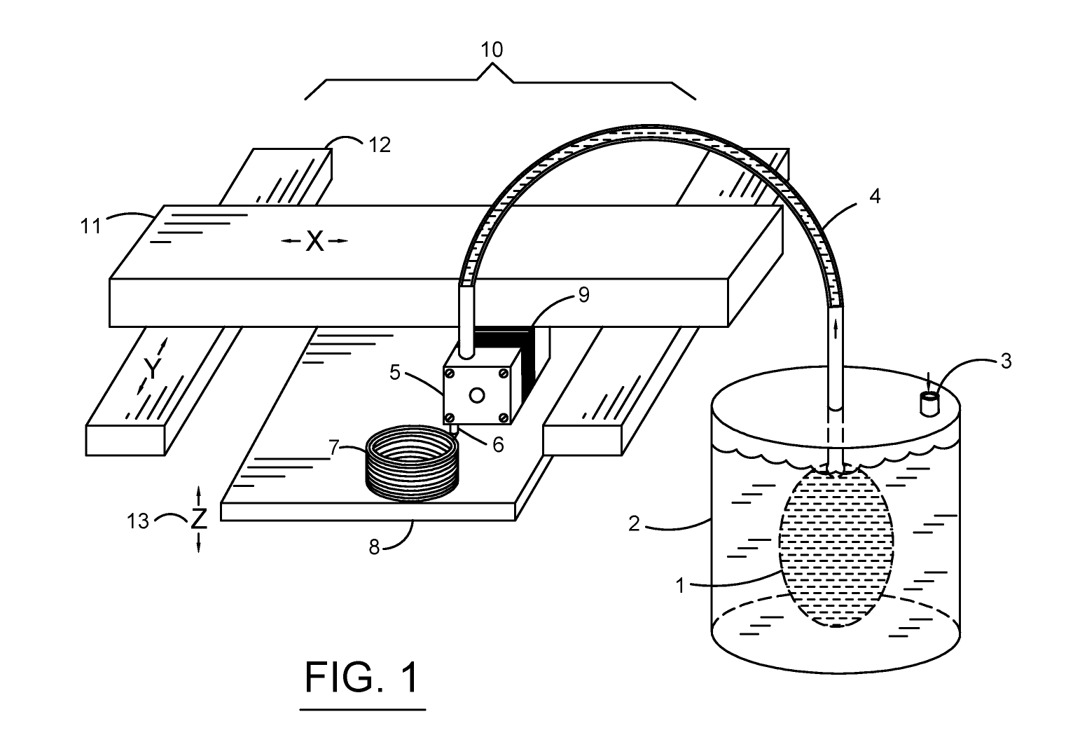

Referring now to FIG. 1, The 3D printer 10 used for 3D printing in this invention is similar to a standard FDM 3D printer for plastics. A nozzle 6 is moved in three directions (X, Y and Z) relative to a formed object 7, which is being built up layer by layer on a build plate 8. Slides 11 and 12 provide the X and Y motion. The build plate 8 can move in the Z direction as shown by 13. The main difference from a conventional FDM machine is the handling of the material as a room-temperature wet paste rather than a molten polymer containing metal. This requires a paste feeder and a metering pump. Metering pump 5 is a positive displacement pump driven by motor 9. The metal paste is stored in a disposable container 1 placed in a strong cylinder 2 pressurized via tube 3. The paste is forced out from container 1 into tube 4 toward pump 5. Container 1 can be in the form of a bag or a disposable cartridge having a disposable piston operated upon by the surrounding pressure in vessel 2. It is desired that the pressurizing fluid delivered via tube 3 will be water rather than air, as an incompressible fluid is safer.

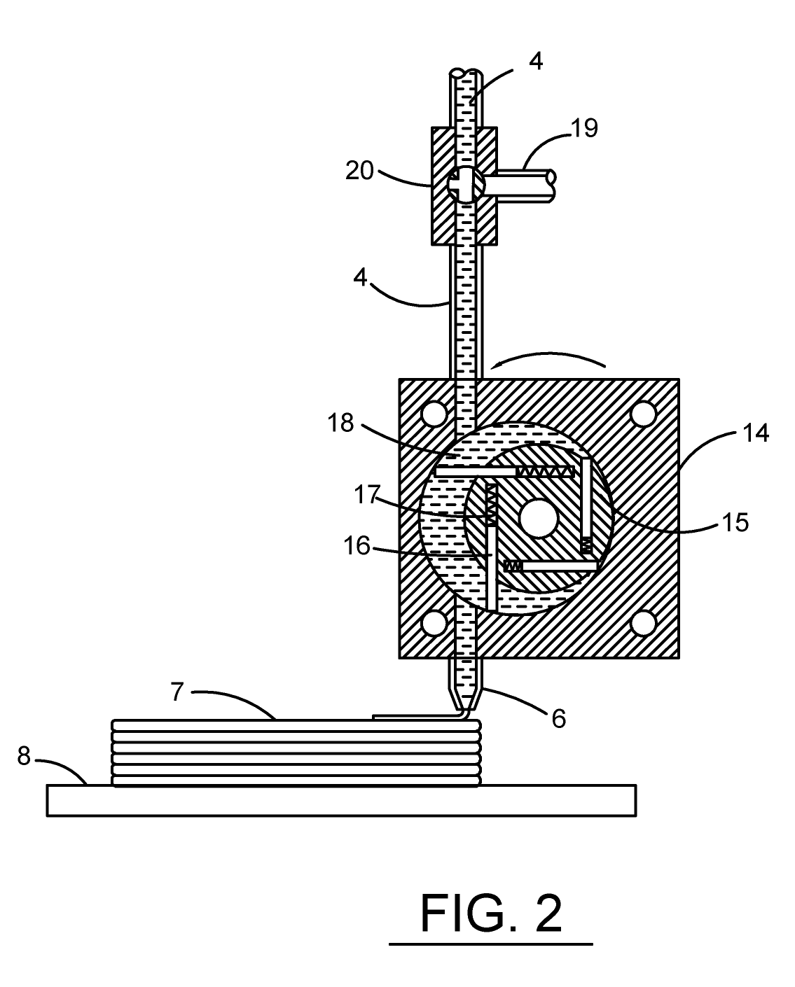

Referring now to FIG. 2, nozzle 6 is fed by a metering pump. The metering pump, located in proximity to the nozzle, has to be capable of generating high pressures as the metal and ceramic pastes are non-Newtonian fluids subject to “shear thinning”. Such pastes can reach very high viscosities at the low flow rates required for 3D printing. Their flow is not at all proportional to the applied pressure. In this disclosure, the term “metering pump” should be interpreted broadly as any pump giving precise control of the amount of extruded paste. These pumps are typically positive displacement pumps such as vane pumps, peristaltic pumps, gear pumps, swash-plate pumps, piston pumps or progressive cavity pumps. By the way of example, the pump shown in FIG. 2 is a vane pump. A rotor 15 rotates inside a housing 14. Four vanes 16, pushed by springs 17, form the pump seals. As motor 9 (shown in FIG. 1) rotates the pump, precise control of the extruded metal paste 18 is achieved. Typically motor 9 is a stepper motor driving the pump via a reduction gear. It is sometimes desired to reverse motor direction for a short time at the end of a period of paste deposition in order to avoid dripping. Another requirement from the metering pump is constant flow. Pumps having a pulsating output, such as reciprocating piston pumps, are not suitable. The preferred embodiment is a rotating pump as it is easier to achieve a constant and uniform flow. The metering pump must have a low trapped volume and should be located as close to the output nozzle 6 as possible. The total trapped volume in the pump and nozzle is preferably under 1 ml, and should not exceed 10 ml.

Sometimes formed object 7 needs a support structure to hold up over-hanging sections. The support structure can be produced in several ways:
1. By the same pump 5 and nozzle 6, using reduced thickness sections for easy break off after object is dry. This is similar to the practice in FDM 3D printers for plastics.
2. By a second pump and nozzle (not shown), depositing a separator layer (sintering inhibitor) between the object and the support. This allows the support structure to be made of the same material as the object, for matched shrinking, but still allowing easy removal of the supports. The separator layer is usually a ceramic paste which stays weak after sintering and can be easily removed. The separator layer prevents the object and support structure from fusing together.
3. A plastic support structure deposited by a conventional FDM head (not shown), typically made of a low temperature filament such as PCL, PLA or wax. The preferred material for a plastic support structure is PCL (Polycaprolactone). The support structure can be easily removed before sintering or allowed to evaporate in the sintering process. Since PCL melts at about 70-80 degrees C., it can be left to flow off the object once the temperature is raised. This eliminates most labor in removing the supports.
4. A support structure made from a low-cost paste, deposited by a similar system to the one shown in FIG. 2. Many FDM 3D printers support dual head operation. The support paste has little or no binder so it is easy to remove when dry. The formed object 7 is much stronger than the support structure when dry. An example of such a low-cost support paste is talc powder mixed with water with some oil added to weaken the dried support. Such a support is easily removable when dry. The fact the support has a very different color from the metal powder assists in the support removal.

The preferred embodiment for support is #4, talc support. Advantages of talc powder as a support material are that it is:
1. Low cost.
2. Non-toxic, can be disposed of anywhere.
3. Soft, does not contribute to pump wear.

If the support structure is required to stay in place during the sintering cycle, a ceramic material having a similar sintering temperature as the metal object should be chosen. For example, kaolinite or magnesium oxide can be used as a support for stainless steel, as the shrinkage during sintering will be comparable. After sintering, the kaolinite can be removed by sand-blasting. Both kaolinite and magnesium oxide are soft materials, reducing pump wear.

Because the metal paste may dry out if the printer is not used, nozzle 6 should be kept submerged in a water container when not used, or the metal paste should be flushed out by water when printing is finished. This can be done by valve 20. Valve 20 can select between a high-pressure water supply 19 and paste supply 4. These operations can be automated and take place at a special “park” position.

An alternative to using a support structure is to solidify and rigidize the paste 18 as soon as it is deposited. This can be done by freezing (e.g. by blowing chilled air or otherwise cooling object 7 to below the freezing point of the paste), or rapid drying, by keeping object 7 at a temperature significantly higher than room temperature, typically 60-120 degrees C. It was discovered that it is important to keep the top layers of object 7 fairly wet, to promote bonding with the newly deposited layer. At the same time, the layers below, and in particularly layers near the base, need to be relatively dry to support the weight of the metal paste above them. Since most FDM printers have a heater installed in bed 8, heating object 7 while printing is simple. Heating from the bottom also generates the desired dryness profile, with the base drier than the top. Additional heat can be provided by blowing warm air at object 7 while it is being printed. Unlike ceramic powders, which develop cracks if dried quickly, it was discovered that metal paste can be dried very quickly without distortion or cracks.

It is also possible to add a rigidizing element to the metal paste, such as a UV curing resin, and expose the emerging paste filament to UV light.

The design of support structures and the use of separation layers is well known in the art of plastic 3D printing and is performed automatically by commercially available software such as Cura or Simplify3D. Sometimes it is desired to create a special environment to assist the 3D printing. Such an environment can be a build chamber that is heated, cooled, humidity controlled or filled with a special gas.

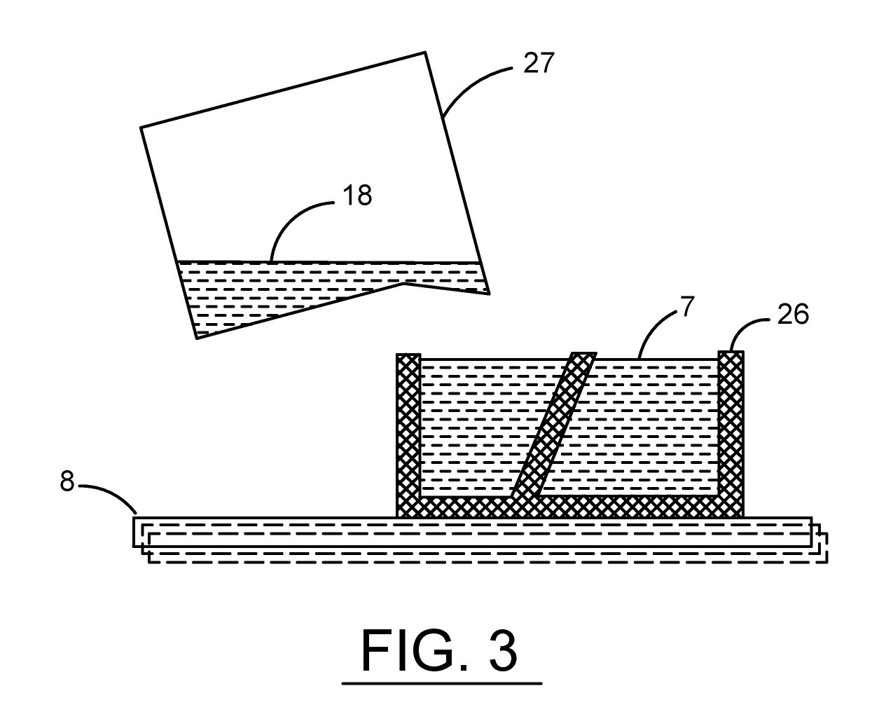

The size of the orifice in nozzles 6 is typically between 0.3 to 1 mm. The nozzles are typically made from hardened stainless-steel type 440C. They can also be made from a hard ceramic such as Zirconia for extra durability. An alternate method of feeding the metal and ceramic support separation pastes is to install an electromagnetically controlled valve in close proximity to nozzle 6. Electromagnetically activated valves are well known in the art. More details about the valve are disclosed in US Patent Application 2016/0325498 (FIGS. 3 and 4) by same inventor as current invention.

The sintering inhibition paste can be made of many materials such as ceramics or materials reacting with the metal powder to form a layer that does not sinter. In particular it was found that a simple mixture of talc powder (3-10 um particle range) and water works well for all metals sintered below 1000 degrees C. For higher temperatures, a mixture of magnesium oxide powder and water works well at least to 2000 degrees C. Another option is kaolinite and water paste.

While the disclosure refers mainly to a “room temperature paste” it should be understood that the disclosure includes pastes that require a slightly elevated temperature to flow, and become a gel at room temperature. The advantage of a paste that gels at room temperature (or at a low temperature) is the reduced need for a support structure, as the printed object is self supporting even in overhanging areas as soon as the paste cools down. A desired temperature range is to have a flowable paste at below 100 degrees C. and a gel below 50 degrees C. One common material having these properties is agar. Agar melts at around 70-80 degrees and is a gel at room temperature. The gelling property can be added to the disclosed paste compositions by adding 1%-5% of agar to the paste. Clearly all the parts of the 3D printer exposed to the paste have to be heated to keep the paste from gelling. When agar is used as a gelling agent the parts exposed to the paste (except the build plate) should be kept at 80-100 degrees C.

### Metal Paste Composition

Any metal paste made up from metal powder, liquid and binder (organic or inorganic) can be used. The metal powder can be the type used in MIM (metal injection molding) or better flowing spherical powder, such as Praxair TRUFORM, formulated for powder bed fusion 3D printers. For higher density, it is sometimes desirable to mix two powders with different particle sizes, such as 30 um average particle size and 5 um average particle size. The ratio of mixing is 60-80% by volume of the larger particle size. The simplest liquid to use is plain water. Alcohol or other liquids can be used for faster drying. For instant drying, liquefied gases (i.e., chemicals that are normally in a gaseous state at room temperature) can be used. An example is liquefied CO₂. The binder can be chosen from a large set of polymeric or inorganic materials. It was discovered that the following binders give good results:

CMC (Carboxymethyl Cellulose) at a concentration of 0.1% to 1% dry weight.

PVA (Poly Vinyl Acetate and also Poly Vinyl Alcohol) at a concentration of 0.2% to 1%. Water based acrylic at a concentration of 0.2% to 2%.

Sodium Silicate at a concentration of 1% to 10%. This binder is mainly suitable for high temperature metals such as stainless steel.

### Drying

Several drying methods can be used, such as air drying, heating or freeze drying. The metal paste dries very well without distortion or cracking as the dried area is highly porous and allows thick sections to dry well. Freeze drying works best for large delicate objects, with a cycle time of 10 to 20 hours. If the sample is dried in a simple convection oven, it is recommended to raise the temperature gradually from 80 degrees C. to 120 degrees C. over a period of several hours.

It is also possible to dry the object as it is being formed by using a heated bed or a heated build chamber. The advantage of this method is the reduced need for a support structure.

### Sintering

The art of sintering metals and ceramics is well known and need not be detailed here. Metals are typically sintered in a reducing gas atmosphere, such as a hydrogen-nitrogen mixture. Ceramics can be sintered in air. Typical sintering times are 1-4 hours once the sintering temperature is reached.

An alternative method of forming object 7 is shown in FIG. 3. A support structure 26 is extended all around the volume the object will occupy until the shape of the object is defined by the support and the object itself no longer needs to be 3D printed. Instead of 3D printing the object, the support is simply filled with metal paste.

In order to ensure filling of complex shapes it is desired to vibrate shell 26 while paste 18 is poured in from container 27. Sometimes it is desirable to vibrate container 27 as well. Since the build plate 8 is removable, it is best to remove it from the 3D printer once shell 26 has been printed, and mount it on a vibrating table. It was found out that adding a small amount of a dispersing agent such as Darvan 811 (Sodium Polyacrylate) greatly improves the filling ability of the metal paste. During the drying process, the supporting shell 26 can be removed or allowed to melt away. The advantage of this embodiment is that no special 3D printer is required, any commercial 3D printer can be used. The printer used to make the shell can be of any type: FDM, Stereolithography, plastic powder fusion etc. For mass production, the shells can be molded, injection molded or vacuum formed. Vacuum formed shells have the advantage that they can be made very thin, allowing the shell to evaporate during the sintering process and eliminating the need for support removal. The process of creating a shell or mold and filling it with a metal or ceramic paste has a certain similarity to the well-known shell casting method or to investment casting. The main difference is that in the prior art methods, the shell or mold needed to resist the action of molten metals, while in the current invention the shaping of the object is performed at room temperature, allowing the shell or mold to be made of a low temperature material such as plastic. This change enables easy 3D printing of the shell. It also allows mass production of the plastic shells by any replication process. A secondary advantage of the mold filling process is that the molds can be made at a higher resolution than an FDM printer can produce, and the dried metal paste object will reproduce this high resolution. By the way of example, the molds can be made by a stereolithography 3D printer (SLA) or injection molding.

### Example 1

A stainless steel paste was prepared by mixing type 316 stainless powder with an average particle size of 30 micron with a 316 stainless powder with average particle size of 5 micron. The powders were of the spherical type (Truform powder, supplied by Praxair USA). 0.5% dry weight of CMC was added to metal powder as a binder. Sufficient water was added to create a thick paste. The paste was blended for 20 minutes in a food type mixer (Breville model BEM800XL). A 3D object was made by extruding the paste from a 0.5 mm diameter nozzle. Feed pressure to pump was about 20 atm (about 300 psi). The 3D printer used was a BCN3D Sigma FDM printer with both heads modified for paste handling. Metering pump was a custom-built stainless steel vane pump with displacement of about 0.5 cc per rotation. Pump motor was a NEMA17 stepper motor geared down 50:1 using a worm gear. The supports were made from the same metal paste. The support separation layer was a kaolinite and water paste, with 0.5% CMC added. It was laid down as a single layer to separate the supports from the final object. The kaolinite was regular kaolinite used in porcelain pottery. The build plate 8 was heated to about 80 degrees C. during the printing process. After printing, the build plate 8 with the printed object were placed in a drying oven for one hour at 120 degrees C. After drying, the object (including support structure), was sintered for 3 hours at 1350 degrees C. in a pure hydrogen atmosphere. After sintering, the object had no detectable porosity and properties similar to bulk 316 stainless. Linear shrinkage was about 15%.

### Example 2

A copper paste was prepared by mixing copper spherical powder with an average particle size of 30 um (Praxair CU-159-6) with MIM type copper powder with average particle size of 5 um. The binder and sample preparation were as in example #1. A 3D object was made by extruding the paste from a 0.5 mm diameter nozzle using a feed pressure of about 20 atm (about 300 psi). The 3D printer used was a BCN3D Sigma FDM printer. The pump and paste deposition head was as in example #1. The second head on this printer had the original FDM configuration, modified for 1.75 mm PCL filament. The supports were deposited with the regular FDM head out of PCL filament supplied by Premium Filaments. After 3D printing, the object was dried in a convection oven for 4 hours at 45 degrees C., followed by 2 hours at 80 degrees C. During this phase the very soft support was removed. The last step of drying was 2 hours at 120 degrees C. Sintering was 6 hours at 1000 degrees C. in a 50% hydrogen/50% nitrogen atmosphere. The gases were dried to a dew point of about −40 degrees C. After sintering, the object had no detectable porosity and properties similar to cast copper, but with slightly lower density.

### Example 3

Using an unmodified 3D printer (BCN3D Sigma) and a PCL filament as in example #2, a shell was printed defining the shape of the desired object. The shell had thinned out areas, allowing it to crack during freeze drying. A zirconia paste was prepared from 5 um average particle size Yttria stabilized Zirconia (supplied by Tosoh, Japan) and water, using 1% Darvan 811 (sodium polyacrylate) as a dispersing agent. The paste preparation used a food mixer as in Example #1. The shell was filled manually with the zirconia paste on a vibrating table, to liquify the paste during filling. The vibrating table was a plate suspended by springs with a small electric motor having an unbalanced mass supplying the vibrations. The filled mold was dried in a freeze dryer (made by Harvest Right, USA) for 20 hours, followed by heating for 2 hours at 80 degrees C. and shell removal while objects were still hot. Sintering was 4 hours at 1550 degrees in air, no support used. A high-quality zirconia part was produced.

### Example 4

A 17-4 stainless steel paste was prepared as in example 1, using a 75% to 25% mixture of 30 um powder and 5 um powder (both Praxair Truform powders). A water/methanol mixture of 20% water 80% methanol was used as a liquid instead of pure water to accelerate solidification while printing. 3% by weight of SAE viscosity grade 30 motor oil was added during mixing. A support paste was prepared by mixing commercial talc powder with average particle size of 3 um (supplied by Imerys USA) and the same water/methanol mixture, forming a thick paste. 5% (by weight) of motor oil was added during mixing. A BCN3D 3D Sigma printer was equipped with two identical pumps and feed systems, one for metal paste and one for support. Feed pressure to pump was 20 atm (about 300 psi). Printing was done using 0.4 mm diameter nozzle on a bed heated to 80 degrees C., followed by oven drying at 120 degrees C. for 1 hour. After drying, the supports were removed by hand with a steel wire brush. Sintering was done for 4 hours at 1350 degrees C. in a 50%/50% hydrogen/nitrogen mixture. Strong, low porosity parts were produced.

### Comparative Example 5

This is an example showing the poor 3D printing and sintering results if the methods disclosed in this invention are not used. An auger (screw) pump was used to pump copper paste. The pump was not located near the nozzle. The 3D printed body showed very low quality. These results are shown in the following publication: “Fabrication of 3D printed Metal Structures by Use of High-Viscosity Paste and Screw Pump Extruder” by Hong et al, Journal of Electronic Materials Vol 44, No 3, 2015. FIG. 1 shows the set-up, FIG. 4 shows the poor printing results and FIG. 6 shows the poor sintering results (high porosity).

1. A method for 3D printing a metal object from a metal paste comprising the following steps:
forming a paste from the desired metal in powder form by adding a liquid and a small amount of binder;
printing the object by extruding said metal paste through a nozzle of a 3D printer using a metering pump located in proximity to the nozzle;
at least partially drying said object as it is being printed, said drying starting at the bottom of the object, and sintering the object.

2. A method for 3D printing a metal object from a metal paste comprising the following steps:
forming a paste from said material in powder form by adding a liquid and a small amount of a gel forming binder, said paste forms a gel at temperatures below 100 degrees C.;
printing the object by extruding said metal paste through the nozzle of a 3D printer using a metering pump located in proximity to the nozzle;
drying and sintering said object.

3. A method for creating a metal object from a metal paste comprising the following steps:
forming a paste from said material in powder form by adding a liquid and a small amount of binder;
creating a plastic shell, the inside of said shell representing the shape of the desired object;
filling said shell with said paste;
drying said object, removing said shell, and sintering the object.

4. A method for 3D printing a metal object from a metal paste as in claim 1, wherein said liquid is water.

5. A method for 3D printing a metal object from a metal paste as in claim 1, wherein said liquid is a mixture of water and alcohol.

6. A method for 3D printing a metal object from a metal paste as in claim 1, wherein a support structure is 3D printed by extruding a ceramic paste; said ceramic paste, when dry, is weaker than the dried object.

7. A method for 3D printing a metal object from a metal paste as in claim 1, wherein said object is built on top of a heated support plate.

8. A method for 3D printing a metal object from a metal paste as in claim 1, wherein a support structure is formed by extruding a paste comprising a low hardness ceramic material and water.

9. A method for 3D printing a metal object from a metal paste as in claim 2, wherein the gel forming material is agar.

10. A method for 3D printing a metal object from a metal paste as in claim 1, wherein said metering pump is a vane pump.

11. A method for 3D printing a metal object from a metal paste as in claim 1, wherein said metering pump is a progressive cavity pump.

12. A method for 3D printing a metal object from a metal paste as in claim 1, wherein said metering pump is a swash-plate pump.

13. A method for 3D printing a metal object from a metal paste as in claim 1, wherein said paste is supplied to said pump out of a disposable cartridge placed in a pressurized vessel.

14. A method for 3D printing a metal object from a metal paste as in claim 1, wherein said paste is supplied to said pump out of a disposable bag placed in a pressurized vessel.

15. A method for 3D printing a metal object from a metal paste as in claim 2, wherein said liquid is water.

16. A method for 3D printing a metal object from a metal paste as in claim 2, wherein said liquid is a mixture of water and alcohol.

17. A method for 3D printing a metal object from a metal paste comprising the following steps:
forming a paste from the desired metal in powder form by adding a liquid and a small amount of binder;
printing the object by extruding said metal paste through a nozzle of a 3D printer using a metering pump located in proximity to the nozzle;
at least partially freezing said object as it is being printed;
freeze drying and sintering said object.
